(19) United States
(12) Patent Application Publication
(10) Pub. No.: US 2026/0367673 A1
(43) Pub. Date: Nov. 19, 2026

(54) TOUCH DEVICE FOR UNDERWATER OPERATION

(71) Applicant: eGalax_eMPIA Technology Inc., Taipei (TW)

(72) Inventor: Wei-Chen LIU, Taipei (TW)

(21) Appl. No.: 19/272,239

(22) Filed: Jul. 17, 2025

(30) Foreign Application Priority Data
May 19, 2025 (TW) 114118722

(51) Int. Cl. G06F 1/16; G06F 3/044

(52) U.S. Cl. CPC G06F 1/1656; G06F 3/0447; G06F 2203/04104

(57) ABSTRACT

A touch device for underwater operation includes a touch module, a housing having a shell and a transparent film, and a medium filled in between the touch module and the housing. When the finger touches and presses down, the transparent film is deformed due to the pressure applied by the finger, and the distance between the finger and the touch panel of the touch module changes, which generates a capacitance signal change, thereby achieving the functions of capacitive touch and multi-point touch in normal air or in a fully immersed environment regardless of sea water or fresh water.

This application claims the priority benefit of Taiwan patent application number 114118722, filed on May 19, 2025.

### BACKGROUND OF THE INVENTION

### 1. Field of the Invention

The present invention provides a touch device for underwater operation, in particular, utilizing the deformation of a transparent film touch medium to cause a change in the capacitance signal of a touch panel, so as to achieve the functions of capacitive touch and multi-point touch in air or in a fully submerged environment of sea water or fresh water.

### 2. Description of the Related Art

With the popularity of touch screens, capacitive touch is widely used. Please refer to FIG. 1 which is a side cross-sectional view of the prior art. When a capacitive touch device 1A is used, and when a human finger touches a touch panel 11A of the touch module, a capacitance signal changes, and the touch device can read the operation behavior of the human finger. Earlier resistive touch usually can only be operated with one finger due to its principle limitation. In contrast, capacitive touch devices have sensitive touch response and can be operated with multiple fingers, so they have become the majority of touch-screen smart device panels today.

However, when the touch device is placed in liquid, the liquid and human fingers have similar capacitance characteristics, so the touch device will not be able to distinguish the human body's operation behavior. Therefore, when the capacitive touch screen and the user are in a fully submerged environment (whether sea water or fresh water), it will not be able to sense the capacitance signal changes after the human finger touches it. Although the use of resistive touch can solve this problem, the limitations of resistive touch as mentioned above will only allow users to perform single-point touch, greatly limiting the operability of underwater touch panels.

In addition, some manufacturers stick silicone on the touch panel. Although this method can achieve the effect of maintaining the capacitance characteristics, simply sticking silicone can easily cause bubbles to form between the silicone layer and the touch panel and it is easy to fall off.

### SUMMARY OF THE INVENTION

Therefore, in view of the above problems and deficiencies, the inventor collected relevant information and, after multiple evaluations and considerations, designed the invention of this touch device for underwater operation.

The main object of the present invention is to provide a touch device that can be used in normal air or in a fully submerged environment regardless of sea water or fresh water, without affecting the capacitive touch and its multi-point touch function, which uses the medium between the touch panel of the touch module and the film. When the finger presses down on the film, it deforms and changes the distance between the finger and the touch panel, thereby generating a stable capacitance signal change.

Another object of the present invention is that the medium is a fluid medium, such as silicone oil or air.

Still another object of the present invention is to provide a waterproof sealing material between the touch module and the housing so that the filling medium is in a sealed state.

### BRIEF DESCRIPTION OF THE DRAWINGS

FIG. 1 is a side cross-sectional view of the prior art.

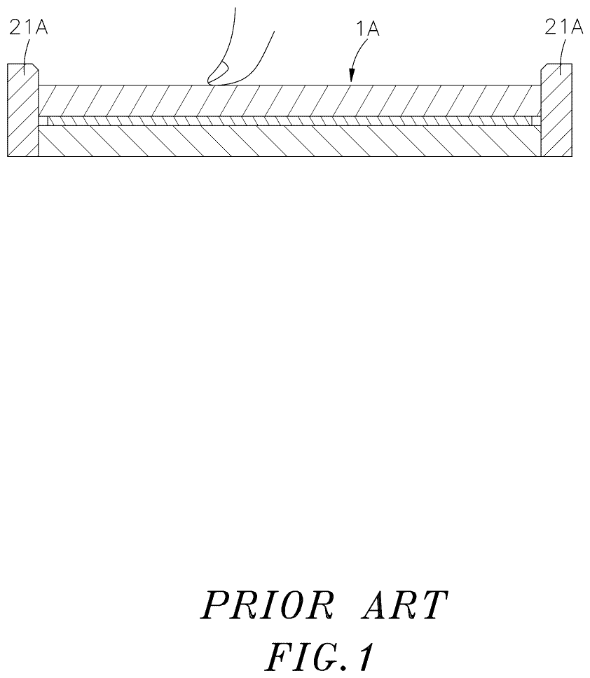

FIG. 2 is a side cross-sectional view of the first embodiment of the present invention.

FIG. 3 is a side cross-sectional view of the first embodiment of the present invention in use.

FIG. 4 is a partial enlarged side cross-sectional view of the second embodiment of the present invention.

FIG. 5 is a partial enlarged side cross-sectional view of the third embodiment of the present invention.

FIG. 6 is a partial enlarged side cross-sectional view of the fourth embodiment of the present invention.

FIG. 7 is a partial enlarged side cross-sectional view of the fifth embodiment of the present invention.

### DETAILED DESCRIPTION OF THE INVENTION

In order to achieve the above objects and effects, the technical means and structures adopted by the present invention are described in detail below with respect to the preferred embodiment of the present invention, so as to facilitate a complete understanding.

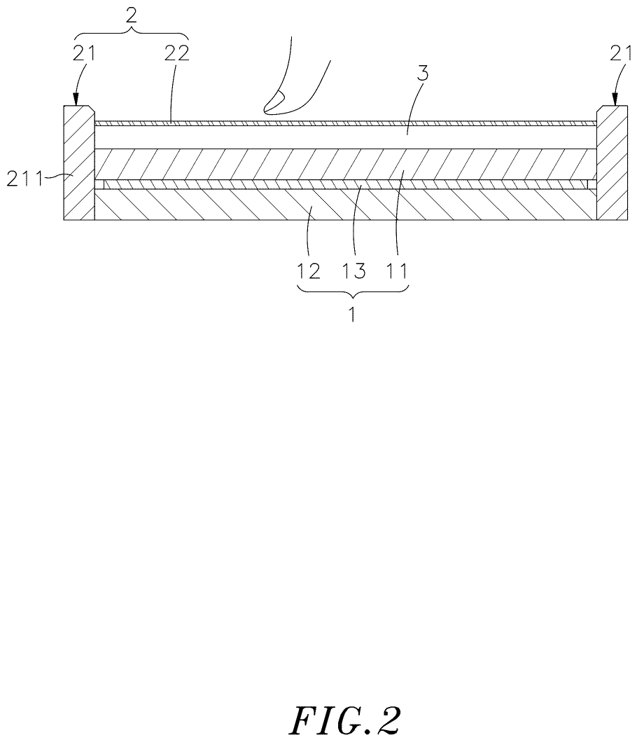

Please refer to FIG. 2, which is a side cross-sectional view of the first embodiment of the present invention. As can be clearly seen from the figure, the present invention comprises a touch module 1, a housing 2 and a medium 3. The touch module 1 comprises a touch panel 11, a screen module 12 and a connection layer 13 provided between the touch panel 11 and the screen module 12. The touch module 1 is covered with the housing 2. The housing 2 comprises a shell 21 coupled to the non-touch area of the touch module 1, and a transparent film 22 coupled to the shell 21 around the touchable area of the touch module 1. The medium 3 is filled in a gap between the transparent film 22 and the touch panel 11. The transparent film 22 may be made of transparent materials such as polymethyl methacrylate (PMMA), but is not limited thereto.

The above-mentioned shell 21 of the housing 2 and the combined transparent film 22 can be integrally formed by injection molding, that is, the transparent film 22 is placed in a mold and then the shell 21 is directly injection molded. This type of in-mold injection technology is a prior art, so it will not be described in detail here.

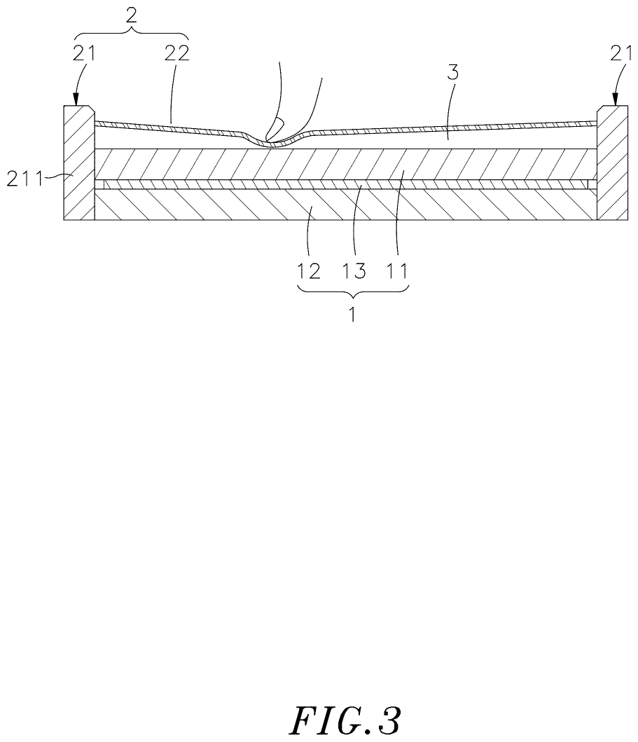

Furthermore, referring to FIG. 3, it is a side cross-sectional view of the first embodiment of the present invention in use. When the user presses down with his finger to touch, the transparent film 22 is deformed due to the pressure applied by the finger, so that the distance between the finger and the touch module 1 changes, and the matrix electrode (not shown in the figure) at the corresponding position in the touch panel 11 of the touch module 1 generates a capacitance signal change. At this time, the medium 3 in the gap between the touch module 1 and the transparent film 22 of the housing 2 will be squeezed to the surroundings, and the medium 3 is squeezed to other positions of the transparent film 22 to present a slightly bulging state with a very small amplitude. When the finger leaves the touch module 1, the surface of the transparent film 22 can return to the original state of the transparent film 22 before being touched as shown in FIG. 2 by its own restoring elasticity and the pressure generated by the medium 3.

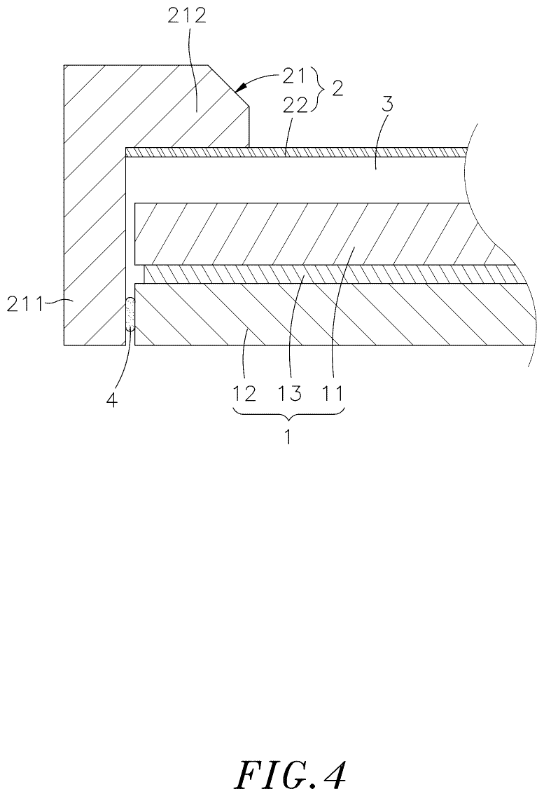

Please refer to FIG. 4, which is a partial enlarged side cross-sectional view of the second embodiment of the present invention. The shell 21 of the housing 2 shown in the first embodiment of the present invention comprises a peripheral frame 211 and a horizontal frame 2111. The bottom of the horizontal frame 2111 at the top of the shell 21 is fixed to the position around the non-touch area of the transparent film 22. A waterproof sealing material 4 is provided around the inner side of the peripheral frame 211 of the shell 21 corresponding to the periphery of the screen module 12 of the touch module 1, so that the medium 3 can be maintained in the gap between the closed space formed by the touch module 1 and the transparent film 22 of the housing 2, and can be fixed by squeezing and clamping. At the same time, the waterproof sealing material 4 can also be further coated with sealing glue to increase the overall tightness and stability. This embodiment is suitable for the design of a narrow-frame touch device and is applicable to shallow water. In addition, the shell 21 and the transparent film 22 can be fixed by applying sealing glue.

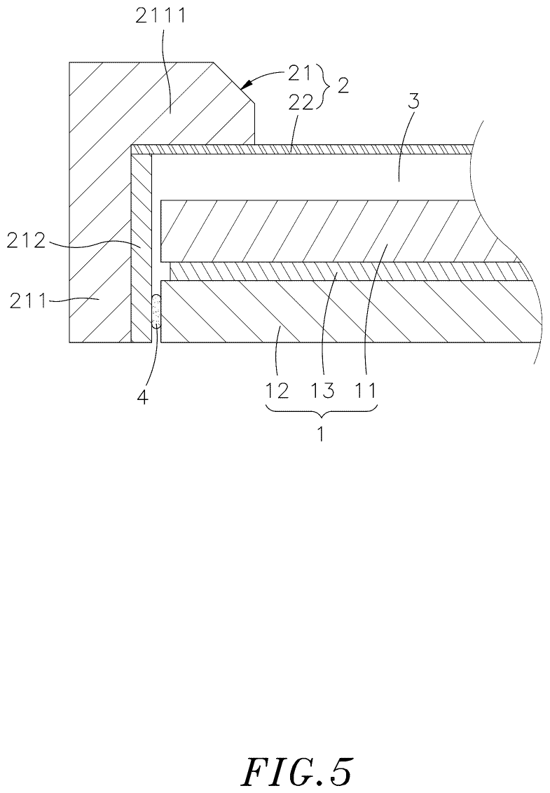

Please refer to FIG. 5, which is a partial enlarged side cross-sectional view of the third embodiment of the present invention. The shell 21 of the housing 2 shown in the second embodiment of the present invention comprises a peripheral frame 211 and a horizontal frame 2111. The bottom of the horizontal frame 2111 at the top of the shell 21 is fixed to the position around the non-touch area of the transparent film 22. The shell 21 is further provided with a clamping block 212 that can be fixed against the inner side of the peripheral frame 211 of the shell 21, and the top end surface of the clamping block 212 can fix the transparent film 22 against the bottom surface of the horizontal frame 2111 of the shell 21 to form a positioning. A waterproof sealing material 4 is provided between the inner side of the clamping block 212 and the outer side of the screen module 12 corresponding to the touch module 1, so that the medium 3 can be maintained in the gap between the closed space formed by the touch module 1 and the transparent film 22 of the housing 2, and can be fixed by squeezing the waterproof sealing material 4. At the same time, the waterproof sealing material 4 can also be further coated with sealing glue to increase the tightness and overall stability. However, the present embodiment uses the clamping block 212 to clamp and fix the transparent film 22, and uses the waterproof sealing material 4 to simultaneously form a close fit between the clamping block 212 and the periphery of the screen module 12. This structure is suitable for use in a narrow-frame touch device, and the overall mechanical strength is better. In addition, the shell 21, the clamping block 212 and the transparent film 22 can be fixed by applying sealing glue.

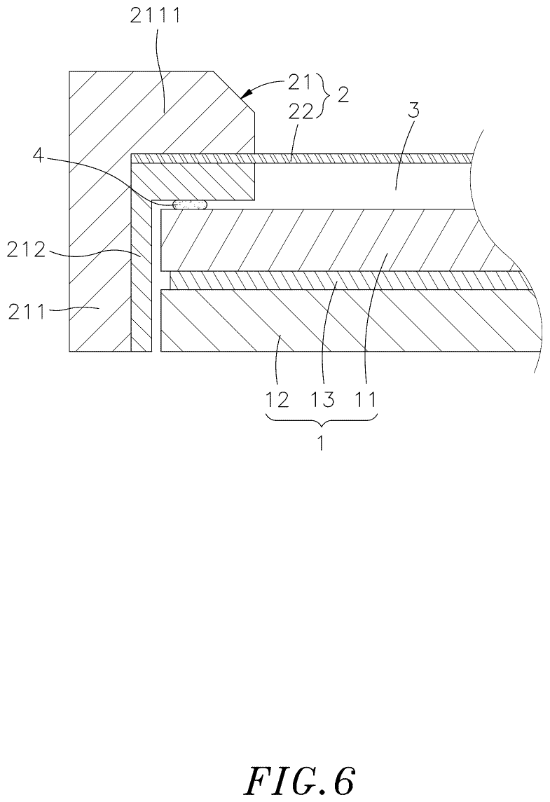

Please refer to FIG. 6, which is a partial enlarged side cross-sectional view of the fourth embodiment of the present invention. The shell 21 of the housing 2 shown in the third embodiment of the present invention comprises a peripheral frame 211 and a horizontal frame 2111. The bottom of the horizontal frame 2111 at the top of the shell 21 is fixed to the position around the non-touch area of the transparent film 22. The shell 21 further utilizes a clamping block 212 of a corresponding shape to abut against the peripheral frame 211 and the horizontal frame 2111, so as to fix the transparent film 22 against the upper bottom surface of the shell 21 to form a positioning. A waterproof sealing material 4 is provided around the bottom surface of the clamping block 212 and around the non-touch area of the upper surface of the touch panel 11 of the touch module 1, so that the medium 3 can be maintained in the gap between the closed space formed by the touch module 1 and the transparent film 22 of the housing 2, and can be fixed by squeezing the waterproof sealing material 4. At the same time, the waterproof sealing material 4 can also be further coated with sealing glue to increase the tightness and overall stability. However, the present embodiment utilizes the large area of the horizontal portion of the clamping block 212 to clamp and fix the transparent film 22, and uses the waterproof sealing material 4 to simultaneously form a close fit between the clamping block 212 and the upper surface of the touch panel 11. This structure is suitable for use in a narrow-frame touch device. The overall mechanical strength is excellent and the structure is stable, which can be applied in deep water. In addition, the shell 21, the clamping block 212 and the transparent film 22 can be fixed by applying sealing glue.

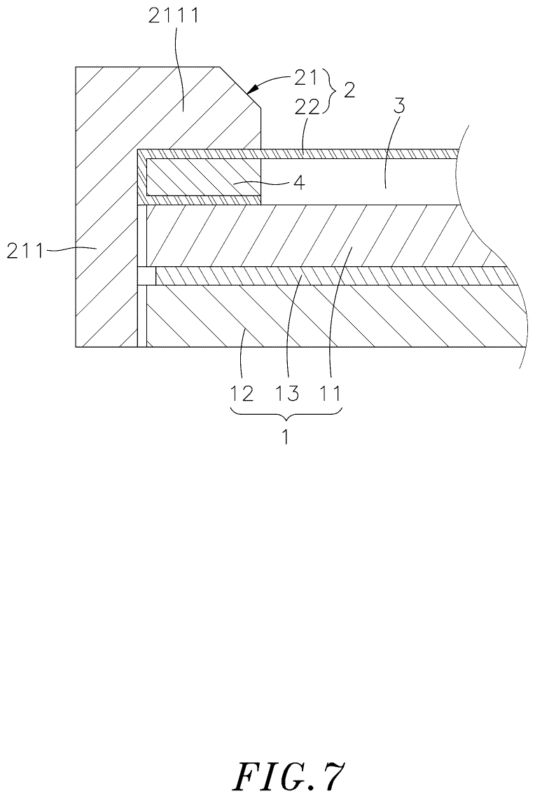

Please refer to FIG. 7, which is a partial enlarged side cross-sectional view of the fifth embodiment of the present invention. The shell 21 of the housing 2 shown in the fourth embodiment of the present invention comprises a peripheral frame 211 and a horizontal frame 2111. The bottom of the horizontal frame 2111 at the top of the shell 21 is fixed to the position around the non-touch area of the transparent film 22. The transparent film 22 is rolled from outside to inside and form top to bottom and wrapped around a hard strip of waterproof sealing material 4, and the suspended end side of the transparent film 22 rolled around the waterproof sealing material 4 is located between the waterproof sealing material 4 and the touch panel 11 to form a close fit. Thus, the medium 3 can be maintained in the gap between the closed space formed by the touch panel 11 and the transparent film 22 of the housing 2, and can be fixed by squeezing the waterproof sealing material 4. At the same time, a sealing glue is applied between the shell 21, the transparent film 22 and the waterproof sealing material 4 to increase the tightness and overall stability. However, the present embodiment uses a transparent film 22 to be wrapped around the waterproof sealing material 4 and simultaneously form a close fit with the touch panel 11. This structure is suitable for use in a narrow-frame touch device. The overall mechanical strength is excellent and the structure is stable, and can be used in deep water.

In the present invention, the shell 21 of the housing 2 can be made of hard materials such as metal, ABS plastic or resin, etc. The above-mentioned materials are prior arts and can be easily understood by those with ordinary knowledge, so they are not described in detail here. Furthermore, the medium 3 may be composed of silicone oil, air or other fluid mediums. Any simple modifications and equivalent structural changes made using the instructions and diagrams of this invention should be included in the patent scope of this invention and should be declared.

In addition, there are switching methods for distinguishing whether the underwater touch device is located in a fully submerged environment and in what type of water environment (sea water, fresh water). The first method is to switch via a manual button or any manual trigger mechanism. The second method is to use a built-in detector of the underwater touch device. For example, using a salinity meter to detect the salinity of water to determine whether it is fresh water or sea water, etc., but the invention is not limited thereto. The detector detects environmental conditions to perform mode switching. The third method is to make a judgment through the characteristics of the capacitance signal detected by the touch device and algorithm analysis. For example, when the touch panel 11 is not immersed in water and a finger touches it, the characteristics of its capacitance signal will be more regular and concentrated. In contrast, when the touch panel 11 is immersed in water, the characteristics of its capacitance signal will be more chaotic and scattered. If the touch panel 11 is immersed in sea water, the above-mentioned more chaotic and scattered situation will be more serious. By judging the above-mentioned characteristics of the capacitance signal, it is possible to determine whether the current capacitance signal is in water, and if so, further determine whether it is immersed in fresh water or sea water.

When the underwater touch device recognizes whether the user is in a fully submerged environment, it performs capacitance signal calibration for the specific environment to achieve the underwater touch function.

The above are only preferred embodiments of the present invention, and do not limit the patent scope of the present invention. Therefore, all simple modifications and equivalent structural changes made by using the contents of the description and drawings of the present invention should be included in the patent scope of the present invention and should be declared.

As mentioned above, the touch device for underwater operation of the present invention can achieve its effect and purpose when used, so the present invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and will be grateful for the convenience.

What is claimed is:

1. A touch device for underwater operation, comprising:
a touch module comprising a touch panel, a connection layer and a screen module arranged in sequence;
a housing comprising a shell coupled to the non-touch area of said touch module, a transparent film coupled to said shell around the touchable area of said touch module, and a gap formed between said transparent film and said touch panel; and
a medium filled in the gap between said transparent film and said touch panel.

2. The touch device for underwater operation as claimed in claim 1, wherein said medium filled in the gap between said touch module and said housing is selectively a silicone oil or air.

3. The touch device for underwater operation as claimed in claim 2, wherein said shell of said housing and said transparent film are made by in-mold injection molding.

4. The touch device for underwater operation as claimed in claim 2, wherein said shell of said housing comprises a peripheral frame and a horizontal frame, said horizontal frame being located on a top side of said shell and having a bottom thereof fixed around the non-touch area of said transparent film; the touch device for underwater operation further comprises a waterproof sealing material disposed around an inner side of said peripheral frame of said shell corresponding to the periphery of said screen module of said touch module.

5. The touch device for underwater operation as claimed in claim 4, wherein said shell and said transparent film are fixed by applying sealing glue.

6. The touch device for underwater operation as claimed in claim 4, wherein said waterproof sealing material is further coated with sealing glue.

7. The touch device for underwater operation as claimed in claim 2, wherein said shell of said housing comprises a peripheral frame and a horizontal frame, said horizontal frame being located on a top side of said shell and having a bottom thereof fixed around the non-touch area of said transparent film; the touch device for underwater operation further comprises a hard strip of waterproof sealing material wrapped by said transparent film from outside to inside and from top to bottom in such a manner that a suspended end side of said transparent film rolled around said waterproof sealing material is located between said waterproof sealing material and said touch panel to form a close fit.

8. The touch device for underwater operation as claimed in claim 7, wherein said shell and said transparent film are fixed with sealing glue.

9. The touch device for underwater operation as claimed in claim 7, wherein said waterproof sealing material is further coated with sealing glue.

10. The touch device for underwater operation as claimed in claim 2, wherein said shell of said housing is installed on a top side and periphery of said screen module of said touch module and having a bottom thereof fixed around the non-touch area of said transparent film; the touch device for underwater operation further comprises a clamping block pressed against a bottom surface and periphery of said shell to hold and fix said transparent film on an upper bottom surface of said shell to form a positioning, and a waterproof sealing material provided around a bottom surface of said clamping block and around the non-touch area on a top surface of said touch panel of said touch module.

11. The touch device for underwater operation as claimed in claim 10, wherein said shell, said clamping block and said transparent film are fixed with sealing glue.

12. The touch device for underwater operation as claimed in claim 10, wherein said waterproof sealing material is further coated with sealing glue.

13. The touch device for underwater operation as claimed in claim 2, wherein said shell of said housing comprises a peripheral frame and a horizontal frame, said horizontal frame being located on a top side of said shell and having a bottom thereof fixed around the non-touch area of said transparent film; the touch device for underwater operation further comprises a hard strip of waterproof sealing material wrapped by said transparent film from outside to inside and from top to bottom in such a manner that a suspended end side of said transparent film rolled around said waterproof sealing material is located between said waterproof sealing material and said touch panel to form a close fit.

14. The touch device for underwater operation as claimed in claim 13, wherein said shell, said transparent film and said waterproof sealing material are fixed with sealing glue.
